(19) United States
(12) Patent Application Publication
(10) Pub. No.: US 2026/0035507 A1
(43) Pub. Date: Feb. 5, 2026

(54) POLYURETHANE FOAM

(71) Applicant: INOAC CORPORATION, Nakamura-ku, Nagoya-shi, Aichi (JP)

(72) Inventor: Takahiko AMANO, Anjo-shi, Aichi (JP)

(21) Appl. No.: 18/997,190

(22) PCT Filed: Jul. 26, 2023
(86) PCT No.: PCT/JP2023/027403

§ 371 Date: Jan. 21, 2025

(30) Foreign Application Priority Data
Jul. 27, 2022 (JP) 2022-119350

(51) Int. Cl. C08G 18/67

(52) U.S. Cl. CPC C08G 18/6755; C08G 2110/0058; C08G 2110/0066; C08G 2110/0083

(57) ABSTRACT

Provided is a polyurethane foam which is obtained from a composition for polyurethane foam, the composition containing a polyol component, a polyisocyanate, a foaming agent and a catalyst. With respect to this polyurethane foam, the polyol component contains a plant-derived polyol and a polymer polyol; the plant degree, which is expressed by the percentage by weight of the plant-derived polyol contained in this composition for polyurethane foam, is 15% or more; and the air permeability (as determined by method A in accordance with JIS K6400-7 (2012)) is 10 L/min or less.

### TECHNICAL FIELD

The present disclosure relates to a suitable polyurethane foam as a sound insulation material.

### BACKGROUND ART

For example, in automobiles, sound insulation materials made of polyurethane foams are arranged in the sound transmission paths around the fenders, instrument panels, cowls, and the like so as to prevent noise from being transmitted into the vehicle interior (Japanese Patent Application Laid-Open (JP-A) No. 2013-246182).

### SUMMARY OF INVENTION

### Technical Problem

Generally, for sound insulation materials of the same material, the heavier they are, the greater the sound insulation effect tends to be.

However, in the case of automobiles, lightweight is required from the viewpoint of improving fuel efficiency. Thus, it is not preferable to increase the polyurethane foam weight to improve sound insulation performance.

Moreover, from the viewpoint of reducing the environmental load in recent years, there has been a demand to use plant-derived resins obtained from plant resources instead of petroleum-derived resins made from petroleum resources.

The disclosure has been made in consideration of the points mentioned above. An object of the disclosure is to provide a polyurethane foam that imparts favorable sound insulation performance even when lightweight and contributes to reducing the environmental load.

### Solution to Problem

A first aspect is a polyurethane foam which is obtained from a polyurethane foam composition including a polyol component, a polyisocyanate, a foaming agent, and a catalyst, wherein the polyol component includes a plant-derived polyol and a polymer polyol, the plant-derived polyol included in the polyurethane foam composition has a plant degree of 15% or more expressed in weight percent, and the polyurethane foam has an air permeability (JIS K6400-7:2012A method) of 10 L/min or less.

A second aspect is the polyurethane foam of the first aspect, wherein a total combined amount of the plant-derived polyol and the polymer polyol in the polyol component is 86% by weight or more.

A third aspect is the polyurethane foam of the first or second aspect, wherein an average sound transmission loss (JIS A1441-1:2007) at frequencies of from 1000 to 6300 Hz is 30 dB or more.

A fourth aspect is the polyurethane foam of any one of the first to third aspects, which has a density of from 100 to 160 kg/m³.

A fifth aspect is the polyurethane foam of any one of the first to fourth aspects, whose surface hardness is an Asker C hardness of 30 or less.

### Advantageous Effects of Invention

According to the disclosure, a polyurethane foam can be obtained, which has favorable sound insulation performance even when lightweight and contributes to reducing the environmental load.

### BRIEF DESCRIPTION OF DRAWINGS

FIG. 1 is a table showing the combinations of compositions for polyurethane foams and the physical properties of the polyurethane foams of Examples and Comparative Examples.

### DESCRIPTION OF EMBODIMENTS

This application is based on Patent Application No. 2022-119350 filed in Japan on Jul. 27, 2022, the contents of which are incorporated herein by reference and form a part of the application. The present invention will be more fully understood from the following detailed description. Further scope of application of the invention will become apparent from the detailed description provided below. However, the detailed description and specific examples, while preferred embodiments of the invention, are set forth for explanation only. From this detailed description, various changes and modifications will become apparent to those skilled in the art without departing from the spirit and scope of the invention. The applicant does not intend to dedicate any of the described embodiments to the public, and all modifications and alternatives that might not literally fall within the scope of the claims are intended to be part of the invention under the doctrine of equivalents.

Hereinafter, embodiments of the invention will be described.

The polyurethane foam of the disclosure is obtained from a polyurethane foam composition including a polyol component, a polyisocyanate, a foaming agent, and a catalyst. By stirring the polyurethane foam composition, the polyol component and the polyisocyanate react with each other and foam, thereby forming a polyurethane foam.

The polyol component includes a plant-derived polyol and a polymer polyol. The plant-derived polyol is a polyol produced using a plant-derived raw material such as vegetable oil. The number of functional groups of the plant-derived polyol is from 2 to 4, and the molecular weight thereof is preferably from 600 to 5000, more preferably from 800 to 4000, still more preferably from 900 to 3000.

Examples of the plant-derived raw material include castor oil, sunflower oil, rapeseed oil, linseed oil, cottonseed oil, tung oil, coconut (palm) oil, poppy seed oil, corn oil, and soybean oil. Among them, a castor oil polyol produced using castor oil as a raw material is a suitable example of the plant-derived polyol in the disclosure.

The castor oil polyol may be either a denatured castor oil polyol or a native castor oil polyol or may contain both.

Examples of the denatured castor oil polyol include transesterification reaction products of castor oil and fats other than castor oil, transesterification reaction products of castor oil and fat fatty acids, transesterification reaction products of castor oil and polyhydric alcohol, esterification reaction products of castor oil fatty acids and polyhydric alcohol, esterification reaction products of some of the hydroxyl groups contained in castor oil and monocarboxylic acids such as acetic acid, reaction products obtained by addition polymerization of these with alkylene oxide, and hydrogenated reaction products obtained by adding hydrogen to these.

Examples of the native castor oil polyol include refined castor oil polyol, semi-refined castor oil polyol, and unrefined castor oil polyol.

A plurality of kinds of plant-derived polyols may be used.

The amount of plant-derived polyol is, for example, preferably an amount that results in a plant degree of 15% or more, more preferably an amount that results in a plant degree of 20% or more, still more preferably an amount that results in a plant degree of 25% or more. The plant degree (%) in the disclosure is a value expressed as the “% by weight” of the plant-derived polyol contained in the polyurethane foam composition. It is calculated as [plant degree (%)=(weight of plant-derived polyol/total weight of polyurethane foam composition)×100].

Examples of the polymer polyol include those obtained by graft-polymerizing acrylonitrile, styrene, and the like onto a polyether polyol and finely dispersing acrylonitrile, styrene, and the like. The number of functional groups of the polymer polyol is from 2 to 4, and the molecular weight thereof is preferably from 2000 to 7000, more preferably from 2500 to 6500, still more preferably from 3000 to 6000. Two or more kinds of polymer polyols may be used in combination. Including a polymer polyol in the polyol component makes it possible to adjust for an excessive decrease in the air permeability of the polyurethane foam caused by the plant-derived polyol. When the air permeability of the polyurethane foam is excessively low, it becomes difficult to compressively deform the polyurethane foam, making it difficult to compress and insert/position it into the sound transmission path, and further, the polyurethane foam becomes more susceptible to shrinkage during molding, which may deteriorate its moldability.

The amount of the polymer polyol is, for example, preferably from 10% to 80% by weight, more preferably from 20% to 70% by weight, still more preferably 30% to 60% by weight, in 100% by weight of the polyol component.

Moreover, the total combined amount of plant-derived polyol and polymer polyol in 100% by weight of the polyol component is, for example, preferably 86% by weight or more, more preferably 88% by weight or more, still more preferably 90% by weight or more.

The polyol component may contain a petroleum-derived polyol in addition to a plant-derived polyol and a polymer polyol. Including a petroleum-derived polyol improves the moldability and productivity of the polyurethane foam.

The petroleum-derived polyol in the disclosure may be any polyol other than a plant-derived polyol and a polymer polyol, which is a polyether polyol, a polyester polyol, a polyether-ester polyol, or the like. One kind or two or more kinds thereof may be used. The number of functional groups of the petroleum-derived polyol is from 2 to 4, and the molecular weight thereof is preferably from 100 to 10000, more preferably from 400 to 8000, still more preferably from 700 to 7000.

The amount of the petroleum-derived polyol is the balance of the plant-derived polyol and polymer polyol in 100% by weight of the polyol component, and is, for example, preferably less than 14% by weight, more preferably less than 12% by weight, still more preferably less than 10% by weight.

The polyisocyanate is not particularly limited as long as it is a compound having two or more isocyanate groups, and any polyisocyanate for polyurethane foams can be used. The polyisocyanate is not limited to one kind; thus, two or more kinds of polyisocyanates may also be used in combination. Examples of polyisocyanate include aromatic, aliphatic, and alicyclic isocyanate compounds and denatured products thereof.

Examples of aromatic isocyanate compounds include diphenylmethane diisocyanate (MDI), crude diphenylmethane diisocyanate, tolylene diisocyanate (TDI), naphthalene diisocyanate (NDI), p-phenylene diisocyanate (PPDI), xylene diisocyanate (XDI), tetramethylxylene diisocyanate (TMXDI), and tolidine isocyanate (TODI). Examples of aliphatic isocyanate compounds include hexamethylene diisocyanate (HDI), lysine diisocyanate (LDI), and lysine triisocyanate (LTI). Examples of alicyclic isocyanate compounds include isophorone diisocyanate (IPDI), cyclohexyl diisocyanate (CHDI), hydrogenated XDI (H6XDI), and hydrogenated MDI (H12MDI). Examples of denatured isocyanate compounds include urethane-denatured, dimeric, trimeric, carbodiimide-denatured, allophanate-denatured, biuret-denatured, urea-denatured, isocyanurate-denatured, and oxazolidone-denatured isocyanate compounds and isocyanate-terminated prepolymers of isocyanate compounds.

The combined amount of polyisocyanate is preferably an amount that results in an isocyanate index of from 70 to 110. In a case in which the isocyanate index is less than 70, the strength of the polyurethane foam will be excessively low, resulting in poor durability, or gas will not easily escape, leading to shrinkage and poor molding quality. On the other hand, when the isocyanate index exceeds 110, the polyurethane foam will have high hardness and will be difficult to deform into the shape of the mating face.

The isocyanate index is a value that indicates, as a percentage, the equivalent ratio of isocyanate groups of a polyisocyanate to the total active hydrogen groups in a polyurethane foam composition (e.g., hydroxyl groups of a polyol or active hydrogen groups of water used as a foaming agent) and is an index used in the field of polyurethane foams.

Examples of the foaming agent can include water, a hydrocarbon, and a halogen-based compound. One kind or two or more kinds of these may be used.

Examples of the hydrocarbon include cyclopentane, isopentane, and normal pentane.

Examples of the halogen-based compound include methylene chloride, trichlorofluoromethane, dichlorodifluoromethane, nonafluorobutyl methyl ether, nonafluorobutyl ethyl ether, pentafluoroethyl methyl ether, and heptafluoroisopropyl methyl ether.

Of these, water is preferred as the foaming agent. The amount of water used as the foaming agent is preferably about from 1% to 10% by weight, more preferably about from 1% to 7% by weight, based on 100% by weight of the polyol component, which makes it possible to adjust the density or the like of the polyurethane foam. Alternatively, it may be from 1 to 10 parts by weight or from 1 to 7 parts by weight per 100 parts by weight of the polyol component.

Examples of the catalyst can include an amine-based catalyst and a metal catalyst.

Examples of the amine-based catalyst include N,N-dimethylcyclohexylamine, N,N-dimethylbenzylamine, N,N-dimethylaminoethanol, N,N′,N′-trimethylaminoethylpiperazine, and triethylenediamine.

Examples of the metal catalyst include tin catalysts such as stannous octoate and dibutyltin dilaurate, phenylmercury propionate, and lead octenate.

The amount of the catalyst is preferably about from 0.1% to 8.0% by weight based on 100% by weight of the polyol. Alternatively, it may be from 0.1 to 8.0 parts by weight per 100 parts by weight of the polyol.

In addition, additives such as a crosslinking agent, a foam stabilizer, a flame retardant, and a colorant are blended, if appropriate, into the polyurethane foam composition.

Examples of crosslinking agents include polyhydric alcohols such as ethylene glycol, diethylene glycol, glycerin, butanetetraol and polyoxypropylene glycol, diethanolamine, and polyamine. The crosslinking agent is not limited to one kind; thus, two or more kinds of crosslinking agents may also be used in combination.

The amount of the crosslinking agent is preferably about from 0.3% to 5% by weight based on 100% by weight of the polyol component. Alternatively, it may be from 0.3 to 5 parts by weight per 100 parts by weight of the polyol component.

The foam stabilizer may be one that can be used in polyurethane foams. Examples thereof can include silicone-based foam stabilizers, fluorine-containing compound-based foam stabilizers, and known surfactants. In particular, silicone-based foam stabilizers are suitable.

The polyurethane foam of the disclosure has an air permeability (JIS K6400-7:2012A method) of, for example, preferably 10 L/min or less, more preferably 6 L/min or less, still more preferably 5 L/min or less, particularly preferably 4 L/min or less. By setting the air permeability within this range, favorable sound insulation performance can be obtained. The lower limit is preferably 1 L/min or more. When the air permeability of the polyurethane foam is excessively low, it becomes difficult to compressively deform the polyurethane foam, making it difficult to compress and insert/position it into the sound transmission path, and further, the polyurethane foam becomes more susceptible to shrinkage during molding, which may deteriorate its moldability. Therefore, the lower limit of air permeability is preferably 1 L/min or more. JIS (Japanese Industrial Standards) refers to Japanese standards relating to industrial products, processing techniques, electromagnetic records, services, business management, and the like.

The polyurethane foam of the disclosure has an average sound transmission loss (JIS A1441-1:2007/ISO 15186-1:2000) of 30 dB or more, preferably 32 dB or more, in a frequency range of from 1000 to 6300 Hz. The higher the average sound transmission loss, the higher the sound insulation performance.

The average sound transmission loss in the 1000-6300 Hz frequency range is calculated by measuring the sound transmission loss (JIS A1441-1:2007/ISO 15186-1:2000) in ⅓ octave bands and calculating the average of sound transmission loss (average transmission loss) in the 1000-6300 Hz frequency range.

The polyurethane foam of the disclosure has a density (JIS K7222:2005) of, for example, preferably less than 170 kg/m³, more preferably less than 160 kg/m³, still more preferably less than 130 kg/m³. By setting the density of polyurethane foam within the range, the polyurethane foam can be made lightweight.

The polyurethane foam of the disclosure has a surface hardness of, for example, preferably 30 or less, more preferably 20 or less, still more preferably 10 or less, as Asker C hardness. By setting the surface hardness of the polyurethane foam within the range, the polyurethane foam can easily adhere to the wall surface shape of the sound transmission path, thereby improving the sound insulation effect.

The polyurethane foam of the disclosure preferably has a skin layer (coat layer) on its surface. The skin layer is a part composed of a layer on the surface of the polyurethane foam that is denser than the inner (center) part of the polyurethane foam. The polyurethane foam has a skin layer such that frictional resistance with the wall surface can be reduced when it is inserted into a gap, facilitating the insertion and placement work. Moreover, the presence of a skin layer (coat layer) increases the sound insulation effect.

The polyurethane foam of the disclosure is produced by molding, during which a polyurethane foam composition is stirred and injected into a foam-molding mold where it is allowed to foam. Molding is a method that is widely used for forming a polyurethane foam. By creating the inner surface of the foam-molding mold into the shape of a product, a polyurethane foam can be obtained in the desired shape without any post-processing.

In polyurethane foam molding, a mold release agent is first applied to the inner surface of the foam-molding mold with a brush or spray. The foam-molding mold has heating means such as an electric heater or a heat transfer medium circulating pipe embedded therein, and the temperature can be adjusted to a specified mold temperature by the electric heater or running hot water or heated oil through the heat transfer medium circulating pipe. The mold temperature is preferably about from 50° C. to 70° C. In a case in which the mold temperature is below 50° C., the curing property may be poor, resulting in insufficient productivity. Conversely, when it is above 70° C., the reactivity of the polyurethane foam composition may be excessively high, the flowability of the polyurethane foam composition may be poor, and there is a risk of underfilling or a rough exterior surface of the polyurethane foam.

The mold release agent preferably contains a solid content (wax component) that has a first melting peak at from 70° C. to 90° C. and a second melting peak at from 100° C. to 130° C. The melting peak is a value measured by a differential scanning calorimeter (DSC) for the solid content remaining after evaporating the liquid component of the mold release agent. When the mold release agent has a first melting peak at from 70° C. to 90° C. and a second melting peak at from 100° C. to 130° C., a polyurethane foam having a favorable skin layer can be obtained.

The mold release agent preferably has a first melting peak at from 70° C. to 90° C. and a second melting peak at from 100° C. to 130° C. and contains a branched-chain wax-based mold release agent. Examples of the branched-chain wax-based mold release agent include those containing branched-chain waxes such as denatured polyethylene wax, microcrystalline wax, and hydrocarbon wax as the main component, which are dissolved in an organic solvent or dispersed in water using an emulsifier. The amount of mold release agent applied is preferably from 10 to 100 g/m².

After applying a mold release agent to the inner surface of the foam-molding mold, the polyurethane foam composition is stirred and injected into the foam-molding mold, which is then closed. The amount of polyurethane foam composition injected into the foam-molding mold is determined according to the density of the resulting polyurethane foam (JIS K7222:2005).

After the polyurethane foam composition has been foamed, the foam-molding mold is opened, and the polyurethane foam is demolded.

### EXAMPLES

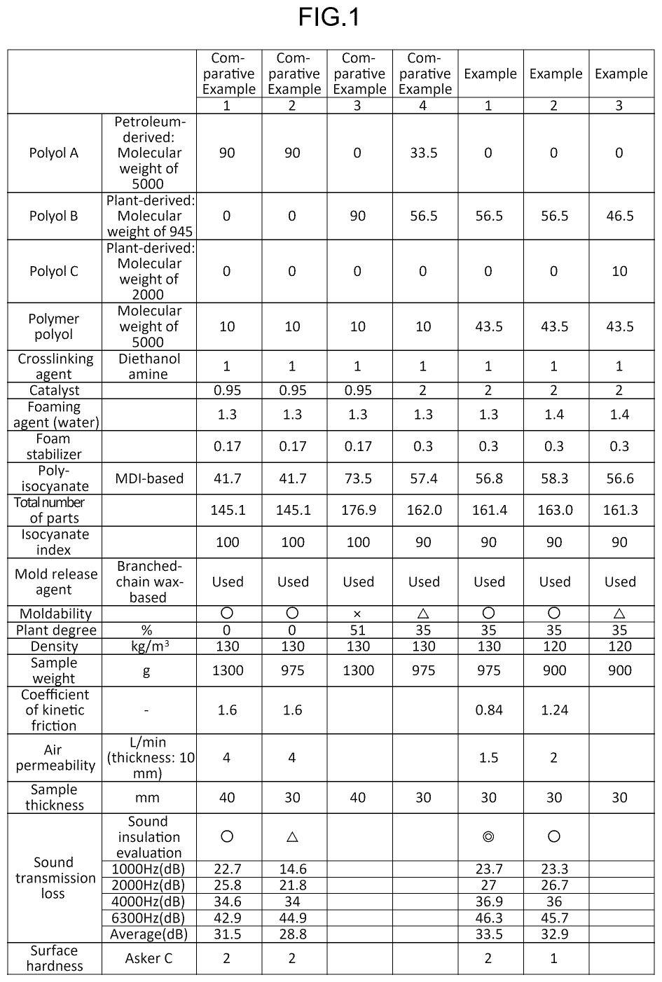

A branched-chain wax-based mold release agent (trade name: N-915 manufactured by CHUKYO YUSHI CO., LTD.; melting point: 48° C.) was sprayed (at a rate of about 25 g/m²) onto the inner surface of a foam-molding mold having a rectangular parallelepiped inner surface shape. Polyurethane foam compositions consisting of the following raw materials based on the combinations shown in FIG. 1 were each stirred and injected into the foam-molding mold in an amount that resulted in the density set for each Example and Comparative Example. The mold temperature was maintained at 60° C., thereby allowing foaming. The polyurethane foams were then demolded, thereby obtaining the polyurethane foams of the respective Examples and Comparative Examples.

For Comparative Examples 1 and 3, a foam-molding mold having inner dimensions of 500×500×40 mm was used. For Comparative Example 4 and Examples 1 to 3, a foam-molding mold having inner dimensions of 500×500×30 mm was used.

In addition, the combined amount of each component in FIG. 1 is expressed as “parts by weight,” and the “total number of parts” is described as the total parts by weight of the polyurethane foam composition.
Polyol A: Petroleum-derived polyether polyol; molecular weight: 5000; number of functional groups: 3; hydroxyl value: 34 mgKOH/g
Polyol B; Plant-derived, castor oil polyol, native (refining treatment); molecular weight: 945; number of functional groups: 2.7; hydroxyl value: 160 mgKOH/g; trade name: H-30 manufactured by ITOH OIL CHEMICALS CO., LTD.
Polyol C; Plant-derived castor oil polyol, denatured type; molecular weight: about 2000; number of functional groups: 3.5; trade name: URIC HF2050 manufactured by ITOH OIL CHEMICALS CO., LTD.
Polymer polyol: molecular weight: 5000: number of functional groups: 3; hydroxyl value: 28 mgKOH/g
Crosslinking agent: Diethanolamine
Catalyst: Amine catalyst; trade name: DABCO 33LV manufactured by Evonik Japan
Foaming agent: Water
Foam stabilizer: silicone foam stabilizer; trade name: SZ1346E manufactured by Dow Toray Co., Ltd.
Polyisocyanate: denatured 4,4′-diphenylmethane diisocyanate; trade name: Coronate 1050 manufactured by Tosoh Corporation

For the polyurethane foam in each Example and Comparative Example, moldability was judged, the plant degree was calculated, and the density, coefficient of kinetic friction, air permeability, sound transmission loss, and surface hardness were measured. Sound insulation performance was evaluated based on the sound transmission loss results.

The symbols representing the evaluation results in FIG. 1 have the following meanings:
“⊚” (Double circle): Excellent
“◯” (Circle): Good
“Δ” (Triangle): Average
“X” (Cross): Poor

The moldability was evaluated by visually observing a demolded polyurethane foam to determine the presence or absence of shrinkage or the like. It was rated as “Good” in a case in which there was no shrinkage, “Average” in a case in which there was slight shrinkage or roughness in the skin layer, and “Poor” in a case in which there was apparent shrinkage or roughness in the skin layer.

$$The plant degree was calculated by \\ ( [ ( number of parts of plant - derived polyol / total \\ number of parts of polyurethane foam composition ) \times 100 ] .$$

The density was determined according to JIS K7222:2005. Specifically, it was calculated by [weight of sample/sample volume (inner mold volume)].

The coefficient of kinetic friction was determined based on JIS K7125. To facilitate sliding the polyurethane foam to place it within a gap, the coefficient of kinetic friction is, for example, preferably 5 or less, more preferably 3 or less, still more preferably 2 or less, particularly preferably 1.5 or less.

For air permeability, the surface air permeability was measured based on the JIS K6400-7:2012A method using a sample (with a skin layer) cut 10 mm from the surface of the polyurethane foam to a size of 51×51×10 mm.

The sound transmission loss was measured in a ⅓ octave band based on JIS A1441-1:2007 at frequencies from 1000 to 6300 Hz, and the average sound transmission loss at frequencies from 1000 to 6300 Hz (average sound transmission loss) was calculated.

The sound transmission loss was measured in a sound source reverberation room of 36 m³, a sound-receiving anechoic room of 20 m³, and a measurement area of 400×400 mm (0.16 m²). A sound insulation material made of polyurethane foam measuring 500 mm square×30 mm or 40 mm (with a skin layer on the surface) was fixed around the periphery with a 50 mm wide frame, and any gaps were further sealed with clay. Sound was introduced from the reverberation room on the sound source side. Measurements were taken at 25 sites (80 mm pitch) 215 mm away from the surface of the sound insulation material from the sound-receiving anechoic room on the non-sound source side at frequencies from 1000 Hz to 6300 Hz, and the average value was calculated.

The sound insulation performance evaluation was carried out as follows: a case in which the average value of sound transmission loss in the 1000-6300 Hz range was 33 dB or more, it was rated “Excellent”; a case in which it was from 30 dB to less than 33 dB, it was rated “Good”; a case in which it was from 25 dB to less than 30 dB, it was rated “Average”; and a case in which it was less than 25 dB, it was rated “Poor.”

The surface hardness was measured using an Asker C hardness tester.

### Comparative Examples 1 and 2

Comparative Examples 1 and 2 are examples in which a polyol consists of petroleum-derived polyol A and a polymer polyol but not a plant-derived polyol, which are different in sample thickness.

In Comparative Example 1, the moldability was “Good,” the plant degree was 0%, the density was 130 kg/m³, and the sample thickness was 40 mm, while the air permeability was 4 L/min, the average value of sound transmission loss in the 1000-6300 Hz range was 31.5 dB, the sound insulation performance evaluation was “Good,” and the Asker C hardness was 2.

In Comparative Example 2, the moldability was “Good,” the plant degree was 0%, the density was 130 kg/m³, and the sample thickness was 30 mm, while the air permeability was 4 L/min, the average value of sound transmission loss in the 1000-6300 Hz range was 28.8 dB, the sound insulation performance evaluation was “Average,” and the Asker C hardness was 2.

Comparative Example 3 is an example in which the polyol consists of 90 parts by weight of a plant-derived polyol B and 10 parts by weight of a polymer polyol.

In Comparative Example 3, the moldability was “Poor,” the plant degree was 51%, the density was 130 kg/m³, and the sample thickness was 40 mm.

In Comparative Example 3, the moldability was insufficient, and thus, a favorable polyurethane foam could not be obtained, making it impossible to determine the coefficient of kinetic friction, air permeability, sound transmission loss, and Asker C hardness.

Comparative Example 4 is an example in which the polyol consists of 33.5 parts by weight of a petroleum-derived polyol A, 56.5 parts by weight of a plant-derived polyol B, and 10 parts by weight of a polymer polyol.

In Comparative Example 4, the moldability was “Average,” the plant degree was 35%, the density was 130 kg/m³, and the sample thickness was 30 mm. Due to insufficient moldability, the evaluation was not carried out.

### Examples 1 and 2

Examples 1 and 2 are examples in which the polyol consists of 56.5 parts by weight of a plant-derived polyol B and 43.5 parts by weight of a polymer polyol, which are different in density.

In Example 1, the moldability was “Good,” the plant degree was 35%, the density was 130 kg/m³, and the sample thickness was 30 mm, while the air permeability was 1.5 L/min, the average value of sound transmission loss in the 1000-6300 Hz range was 33.5 dB, the sound insulation performance evaluation was “Excellent,” and the Asker C hardness was 2.

Example 1 has better sound insulation performance than Comparative Example 2, which is comparable to Example 1 in sample thickness and density and has favorable moldability.

In Example 2, the moldability was “Good,” the plant degree was 35%, the density was 120 kg/m³, and the sample thickness was 30 mm, while the air permeability was 2 L/min, the average value of sound transmission loss in the 1000-6300 Hz range was 32.9 dB, the sound insulation performance evaluation was “Good,” and the Asker C hardness was 1.

Although Example 2 has a lower density and is more lightweight than Comparative Example 2, it has better sound insulation performance than Comparative Example 2.

### Example 3

Example 3 is an example in which the polyol consists of 46.5 parts by weight of a plant-derived polyol B, 10 parts by weight of a plant-derived polyol C, and 43.5 parts by weight of a polymer polyol.

In Example 3, the moldability was “Average,” the plant degree was 35%, the density was 120 kg/m³, and the sample thickness was 30 mm. Due to insufficient moldability, the evaluation was not carried out.

Thus, according to the disclosure, a polyurethane foam can be obtained, which has favorable sound insulation performance even when lightweight and contributes to reducing the environmental load.

The polyurethane foam of the disclosure is suitable not only for placement on wall surfaces or spaces where sound insulation is required but also for sound insulation applications in which the polyurethane foam is compressed and slid into gaps in the sound transmission path and then elastically restored to fill the gaps after placement; it is particularly suitable as a sound insulation material for a vehicle, which requires lightweight and sound insulation performance.

The invention is not limited to Examples and can be modified without departing from the spirit of the invention.

All references cited herein, including publications, patent applications, and patents, are herein incorporated by reference as if each individual reference were specifically and individually indicated to be incorporated by reference, and all their contents are incorporated herein by reference to the same extent as if set forth herein.

The use of nouns and similar referents used in connection with the description of the invention (particularly in connection with the following claims) are to be construed as covering both the singular and the plural unless otherwise indicated herein or clearly contradicted by context. The terms “comprising,” “having,” “including,” and “encompassing” are to be construed as open-ended terms (i.e., meaning “including, but not limited to”) unless otherwise noted. Unless otherwise stated herein, the recitation of numerical ranges herein is merely intended to serve as a shorthand method of referring individually to each value falling within that range, and each value is incorporated herein as if each was individually recited herein. All methods described herein can be performed in any suitable order unless otherwise indicated herein or otherwise clearly contradicted by context. Any examples or exemplary phrases used herein (e.g., “such as”) are intended merely to explain the invention better and do not pose limitations on the scope of the invention unless otherwise stated. No language used herein should be construed as indicating any non-claimed element as essential to the practice of the invention.

Preferred embodiments of the invention are described herein, including the best mode known to the inventors for carrying out the invention. Variations of these preferred embodiments will become apparent to those skilled in the art upon reading the above description. The inventors anticipate that those skilled in the art will apply such variations, if appropriate, and intend to practice the invention other than as specifically described herein. Accordingly, the invention includes all modifications and equivalents of the subject matter recited in the claims appended hereto as permitted by applicable law. Moreover, any combination of the above-described elements in all variations thereof is encompassed by the invention unless otherwise indicated herein or otherwise clearly contradicted by context.

1. A polyurethane foam, which is obtained from a polyurethane foam composition including a polyol component, a polyisocyanate, a foaming agent, and a catalyst, wherein:
the polyol component includes a plant-derived polyol and a polymer polyol,
the plant-derived polyol included in the polyurethane foam composition has a plant degree of 15% or more expressed in weight percent, and
the polyurethane foam has an air permeability, according to the method of JIS K6400-7:2012A, of 10 L/min or less.

2. The polyurethane foam according to claim 1, wherein a total combined amount of the plant-derived polyol and the polymer polyol in the polyol component is 90% by weight or more.

3. The polyurethane foam according to claim 1, wherein an average sound transmission loss, as defined in JIS A1441-1:2007, at frequencies of from 1000 Hz to 6300 Hz is 30 dB or more.

4. The polyurethane foam according to claim 1, which has a density of from 120 kg/m³ to less than 170 kg/m³.

5. The polyurethane foam according to claim 1, whose surface hardness is an Asker C hardness of 30 or less.

6. The polyurethane foam according to claim 1, which has, on a surface thereof, a wax component having a first melting peak at from 70° C. to 90° C. and a second melting peak at from 100 to 130° C.

7. The polyurethane foam according to claim 1, which has a coefficient of kinetic friction of 5 or less.

8. A sound insulation material, comprising the polyurethane foam according to claim 1.

9. A sound insulation material for a vehicle, the material comprising the polyurethane foam according to claim 1.

10. The polyurethane foam according to claim 1, wherein the air permeability is 6 L/min or less.

11. The polyurethane foam according to claim 2, wherein the polyol component consists essentially of the plant-derived polyol and the polymer polyol.

12. The polyurethane foam according to claim 3, wherein the average sound transmission loss at frequencies of from 1000 to 6300 Hz is 32 dB or more.

13. The polyurethane foam according to claim 12, wherein the average sound transmission loss at frequencies of from 1000 to 6300 Hz is 33 dB or more.

14. The polyurethane foam according to claim 4, wherein the density is from 120 kg/m³ to 130 kg/m³.
